(19) United States
(12) Patent Application Publication
(10) Pub. No.: US 2023/0324905 A1
(43) Pub. Date: Oct. 12, 2023

(54) REMOTE DRIVING CONTROL METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventors: Yipeng ZHANG, Shenzhen (CN); Yixue LEI, Shenzhen (CN)

(21) Appl. No.: 18/208,747

(22) Filed: Jun. 12, 2023

Related U.S. Application Data
(63) Continuation of application No. PCT/CN2022/132500, filed on Nov. 17, 2022.

(30) Foreign Application Priority Data
Apr. 8, 2022 (CN) 202210370062.6

(51) Int. Cl. G05D 1/00; H04W 4/40

(52) U.S. Cl. CPC G05D 1/0022; G05D 2201/0213; H04W 4/40

(57) ABSTRACT

This application provides a remote driving control method performed by an electronic device mounted on a vehicle, and is applicable to the field of intelligent transportation. The remote driving control method includes: obtaining prediction information of a first area, the prediction information indicating network quality of the first area at a first time when the vehicle is scheduled to travel in the first area at the first time; determining, based on the prediction information, a control policy of the remote driving vehicle at the first time; adjusting a traveling parameter of the vehicle based on the control policy before the first time; and controlling the vehicle to travel in the first area at the first time through remote driving in accordance with the adjusted traveling parameter.

### CROSS-REFERENCE TO RELATED APPLICATIONS

This application is a continuation application of PCT Patent Application No. PCT/CN2022/132500, entitled “REMOTE DRIVING CONTROL METHOD AND APPARATUS, DEVICE, STORAGE MEDIUM, AND PROGRAM PRODUCT” filed on Nov. 17, 2022, which claims priority to Chinese Patent Application No. 202210370062.6, entitled “REMOTE DRIVING CONTROL METHOD AND APPARATUS, DEVICE, STORAGE MEDIUM, AND PROGRAM PRODUCT” filed on Apr. 8, 2022, all of which is incorporated herein by reference in its entirety.

### FIELD OF THE TECHNOLOGY

Embodiments of this application relate to the field of intelligent transportation technologies, and in particular, to a remote driving control method and apparatus, a device, a storage medium, and a program product.

### BACKGROUND OF THE DISCLOSURE

With continuous development of automobile intelligence, a remote driving technology emerges. Through remote control of a vehicle by a person, the remote driving technology can reduce or avoid interference of uncertain factors on a road to a certain extent, and in particular, implement remote monitoring in a harsh environment, in a dangerous area, and in a case of an emergency of the vehicle, thereby having a broad application prospect.

Based on characteristics of high bandwidth and low delay of a network, the remote driving transmits collected scene information around the vehicle to a cloud driving cabin. The cloud driving cabin displays the scene information through a display, and a remote driver determines and performs an operation based on the scene information to remotely control the vehicle. The remote driving has high requirements for delay, bandwidth, and reliability of a network. For example, the remote driving requires an uplink bandwidth of 36 Mbps, has a delay requirement of 100 ms for uplink and 20 ms for downlink, and has a reliability requirement of 99% for uplink and 99.999% for downlink.

In related art, when network quality changes suddenly, no sufficient time can be reserved for a remote driving system or a remote driver, resulting in lower safety of remote driving.

### SUMMARY

This application provides a remote driving control method and apparatus, an electronic device, a non-transitory computer-readable storage medium, and a computer program product, which can help improve the safety of remote driving.

An embodiment of this application provides a remote driving control method performed by an electronic device mounted on a vehicle, and the method including:
obtaining prediction information of a first area, the prediction information indicating network quality of the first area at a first time when the vehicle is scheduled to travel in the first area at the first time;
determining, based on the predicted information, a control policy of the vehicle at the first time;
adjusting a traveling parameter of the vehicle based on the control policy before the first time; and
controlling the vehicle to travel in the first area at the first time through remote driving in accordance with the adjusted traveling parameter.

An embodiment of this application provides an electronic device mounted on a vehicle, including: a processor and a memory, wherein the memory is configured to store computer-executable instructions that, when executed by the processor, cause the electronic device to perform the remote driving control method provided in the embodiments of this application.

An embodiment of this application provides a non-transitory computer-readable storage medium, storing computer-executable instructions, wherein the computer-executable instructions, when executed by a processor of an electronic device mounted on a vehicle, cause the electronic device to perform the remote driving control method provided in the embodiments of this application.

An embodiment of this application provides a computer program product, including a computer program or computer-executable instructions, where when the computer program or the computer-executable instructions are executed by a processor, the remote driving control method provided in the embodiments of this application is implemented.

The technical solutions provided in the embodiments of this application may bring the following beneficial effects:

In the embodiments of this application, the network quality of the first area at the first time is known by obtaining the prediction information of the first area, to predict a network quality change at a future time, so that a remote driving system can adjust, based on the predicted network quality, the traveling parameter of the vehicle before the network quality actually changes. This helps reduce or avoid a problem of network lags in the vehicle caused by sudden change of a network, thereby helping improve the safety of vehicle traveling.

### BRIEF DESCRIPTION OF THE DRAWINGS

FIG. 1 is a schematic diagram of an application scenario according to an embodiment of this application.

FIG. 2 is a schematic flowchart of a remote driving control method according to an embodiment of this application.

FIG. 3 is a schematic flowchart of another remote driving control method according to an embodiment of this application.

FIG. 4 is a schematic flowchart of another remote driving control method according to an embodiment of this application.

FIG. 5 is a schematic flowchart of another remote driving control method according to an embodiment of this application.

FIG. 6 is a schematic block diagram of a remote driving control apparatus according to an embodiment of this application.

FIG. 7 is a schematic block diagram of another remote driving control apparatus according to an embodiment of this application.

FIG. 8 is a schematic block diagram of another remote driving control apparatus according to an embodiment of this application.

FIG. 9 is a schematic block diagram of an electronic device according to an embodiment of this application.

### DESCRIPTION OF EMBODIMENTS

The following clearly and completely describes the technical solutions in the embodiments of this application with reference to the accompanying drawings in the embodiments of this application.

It is to be understood that, in the embodiments of this application, ‘B corresponding to A’ indicates that B is associated with A. In an implementation, B may be determined based on A. It is to be further understood that determining B based on A does not merely mean that B is determined based on A, B may also be determined based on A and/or other information.

In the description of the embodiments of this application, unless otherwise stated, “at least one” indicates one or more, and “a plurality of” indicates two or more than two. In addition, “and/or” describes an association relationship between associated objects and represents that three relationships may exist. For example, A and/or B may represent the following cases: Only A exists, both A and B exist, and only B exists, where A and B may be singular or plural. The character “/” generally indicates an “or” relationship between the associated objects. “At least one of the following items” or a similar expression means any combination of these items, including a single item or any combination of a plurality of items. For example, at least one of a, b, or c may represent a, b, c, a and b, a and c, b and c, or a, b, and c, where a, b, and c may be singular or plural.

It is to be further understood that the description of first and second in the embodiments of this application are only used for illustrating and distinguishing described objects without a sequence, does not indicate a special limitation on the number of devices in the embodiments of this application, and cannot constitute any limitation on the embodiments of this application.

It is to be further understood that particular features, structures or characteristics related to the embodiments mentioned in the specification are included in at least one embodiment of this application. In addition, the particular features, structures or characteristics may be combined in one or more embodiments in any appropriate manner.

Moreover, the terms “include”, “contain” and any other variants mean to cover non-exclusive inclusion. For example, a process, method, system, product, or server that includes a series of steps or units is not necessarily limited to those expressly listed steps or units, but may include other steps or units that are not expressly listed or inherent to the process, method, system, product, or device.

The solutions provided by this application are applicable to the field of intelligent transportation.

An intelligent traffic system (ITS) is also referred to as an intelligent transportation system, and effectively and comprehensively applies advanced science and technology (for example, an information technology, a computer technology, a data communication technology, a sensor technology, an electronic control technology, an automatic control theory, operational research, and artificial intelligence) to transportation, service control and vehicle manufacturing, so as to strengthen a connection between a vehicle, a road, and a user, thereby forming a comprehensive transportation system for ensuring safety, improving efficiency, improving the environment, and saving energy.

The embodiments of this application may relate to a remote driving technology in the technical field of intelligent transportation. The remote driving is a technology that transmits, based on characteristics of high bandwidth and low delay of a network, scene information around a vehicle and collected by a sensor such as a vehicle-mounted camera or a radar to a cloud driving cabin, for the cloud driving cabin to display the scene information through a display, and for a driver to determine and perform an operation based on the scene information to remotely control the vehicle. The remote driving technology is applicable to a remote control scenario of a vehicle, can remotely control the vehicle in a harsh environment, in a hazardous area, or in a case of an emergency of the vehicle, thereby having a broad application prospect.

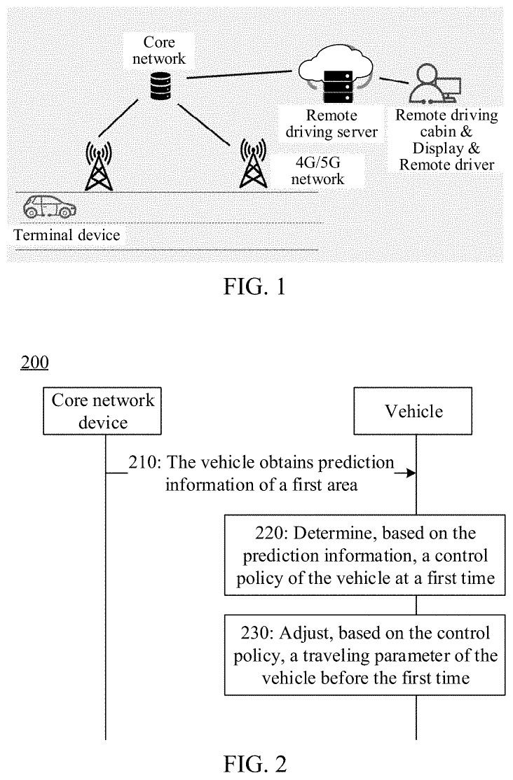

FIG. 1 is a schematic diagram of an application scenario according to an embodiment of this application.

As shown in FIG. 1, a cloud platform, a network side device, and a terminal device are included. The terminal device may include an intelligent connected vehicle, a vehicle-mounted terminal, or user equipment. This is only a schematic explanation and does not limit an application scenario of the embodiments of this application.

The intelligent connected vehicle refers to an organic combination of the Internet of Vehicles and an intelligent vehicle. The intelligent connected vehicle is a new-generation vehicle that can carry advanced single-vehicle intelligent apparatuses such as a vehicle-mounted sensor, a controller, and an actuator, and can further exchange and share intelligent information between a vehicle and a person, a vehicle, a road, and a backend through a communication network (for example, the 5G network). The intelligent connected vehicle may perform remote driving.

The vehicle-mounted terminal may include a trip computer, or an on-board unit (OBU). The vehicle-mounted terminal may alternatively be a T-BOX, an APP on a terminal, an APP on a smart rearview mirror, an APP or an applet on a mobile phone, or the like, which is not limited herein.

The user equipment (UE) may be a wireless terminal device or a wired terminal device. The wireless terminal device may refer to a device with a wireless transceiver function, such as a mobile phone, a pad, a computer with a wireless transceiver function, virtual reality (VR) user equipment, augmented reality (AR) user equipment, or the like, which is not limited herein.

The network side device may include a traffic control unit, an access network device (for example, a base station), a core network device, a road side device, and the like. The traffic control unit is a functional entity forming a control subsystem in the intelligent transportation system, and coordinates traffic activities of a vehicle, a road, and a person based on traffic information to ensure traffic safety and traffic efficiency. The traffic information includes information about a vehicle, a pedestrian, a road, a facility, weather, and the like, and the information may be obtained through a vehicle, a pedestrian, or a road side unit.

The road side unit (RSU) is a traffic information collection unit or a traffic facility control unit deployed near a road. The former provides collected traffic information to the traffic control unit, and the latter executes control instructions from a traffic control unit on a traffic facility.

The network side device communicates with the terminal device through a network. A description is provided by using an example in which the network is a 5G network. The 5G network may also be replaced by a wireless network such as Global System of Mobile Communications (GSM), Wideband Code Division Multiple Access (WCDMA), a 4G network, a next-generation network, Bluetooth, Wi-Fi, or a call network, which is not limited.

The cloud platform sends operation instructions of a remote driver in a remote driving cabin to a remote driving vehicle, and displays processed backhaul data and status information of the vehicle to the driver. For example, the cloud platform may include a remote driving server, a remote driving cabin, and a display.

For example, the remote driving vehicle may collect traffic and road environment information around the vehicle through a sensor on the vehicle (for example, a camera, a laser radar or a millimeter-wave radar), and transmit, based on a communication network, the collected information to the remote driving server. The remote driving server displays the information on a screen (namely, the display) of a remote driving controller. The remote driver determines a real-time traffic environment around the vehicle through the screen, and operates a driving simulator to emit signals including rotating a steering wheel, accelerating, and braking to control the vehicle, to enable the vehicle to travel safely in an expected route and state.

There may be one or more servers. When there are a plurality of servers, at least two servers are configured to provide different services, and/or at least two servers are configured to provide a same service, for example, provide a same service in a load-balancing manner. This is not limited in the embodiments of this application.

The server may be an independent physical server, a physical server cluster or a distributed system including a plurality of physical servers, or a cloud server providing basic cloud computing services, for example, a cloud service, a cloud database, cloud computing, a cloud function, cloud storage, a network service, cloud communication, a middleware service, a domain name service, a security service, a content delivery network (CDN), and big data and an artificial intelligence platform. The server may also be a node of a blockchain.

To ensure safe traveling, the remote driving has high requirements for delay, bandwidth, and reliability of a network. For example, the remote driving requires an uplink bandwidth of 36 Mbps, has a delay requirement of 100 ms for uplink and 20 ms for downlink, and has a reliability requirement of 99% for uplink and 99.999% for downlink. A remote driving control solution is to change a remote driving mode based on network quality of the vehicle at a current time. In this solution, when the network quality suddenly changes, no sufficient time can be reserved for a remote driving system or a remote driver, leading to a safety risk.

Based on this, an embodiment of this application provides a remote driving control solution that can predict a network quality change at a future time, so that the remote driving system can adjust, based on the predicted network quality, a parameter of a sensor of the vehicle before the network quality actually changes. This helps reduce or avoid a problem of backhaul data lags in the vehicle caused by a sudden change of a network, thereby helping improve the safety of vehicle traveling.

The following describes a remote driving control method involved in the embodiments of this application with reference to the accompanying drawings.

FIG. 2 is a schematic flowchart of a remote driving control method 200 according to an embodiment of this application. An execution body of the method 200 may be any electronic device with a data processing capability, and the electronic device may be implemented as a terminal device, for example, the terminal device in FIG. 1. For ease of description, the following embodiments are described by using an example in which the terminal device is a remote driving vehicle, but this application is not limited thereto.

In the method 200, the vehicle obtains prediction information of network quality, and determines a control policy of the vehicle at a first time based on the prediction information. In other words, in the method 200, after the remote driving vehicle receives the prediction information of the network quality, the control policy of the vehicle is adjusted.

As shown in FIG. 2, the method 200 may include step 210 to step 230.

Step 210: The vehicle obtains prediction information of a first area.

The prediction information is used for indicating network quality of the first area at the first time. The first time is a moment or a time period in the future using a current time point as a reference, which is not limited. The vehicle travels in the first area at the first time through remote driving.

In some embodiments, when the network quality is about to change, a core network device can predict a change of the network quality of the first area at the first time in the future in advance, and the remote driving vehicle can obtain the prediction information of the first area from the core network device.

For example, the first time is a time point in the future using the current time point as a reference. The remote driving vehicle transmits a prediction information obtaining request corresponding to the first time to the core network device. The core network device returns, in response to the prediction information obtaining request, prediction information for indicating the network quality of the first area at the first time, to inform the vehicle of the network quality of the first area at the first time in the future.

In some other embodiments, the first time is a time period in the future using the current time point as a reference. The core network device automatically and periodically transmits prediction information to the vehicle, to inform the vehicle of the network quality of the first area at the first time in the future time period using the current time point as a reference.

For example, the network quality may be indicated by at least one of the following parameters: at least one of transmission bandwidth, transmission delay, transmission reliability, and delay jitter. For example, when the network quality is indicated by transmission bandwidth, wider network bandwidth indicates higher corresponding network quality; or when the network quality is indicated by transmission bandwidth and transmission delay, smaller transmission delay indicates higher corresponding network quality, the transmission bandwidth and the transmission delay may respectively have corresponding weights, and final network quality may be obtained by performing weighted summation on the network quality indicated by the transmission bandwidth and the transmission delay. In some embodiments, the prediction information may indicate a value (size) of the network quality, or the prediction information may indicate a network quality level. For example, when the value of the network quality is lower than a preset first threshold, the prediction information may indicate that the network quality is low; when the value of the network quality is higher than a second threshold, the prediction information may indicate that the network quality is high, where the first threshold is smaller than the second threshold; and when the value of the network quality is between the first threshold and the second threshold, the network quality indicated by the prediction information is normal. Values of the first threshold and the second threshold may be set based on an actual requirement.

In a possible implementation, the core network device may determine the foregoing prediction information based on a parameter of a wireless communication network and traveling information of the vehicle. In some embodiments, the traveling information of the vehicle may include an environment parameter of the vehicle (for example, a road condition of the vehicle during traveling, or obstacle information around the vehicle). For example, the core network device may determine, based on the traveling information of the vehicle, that the vehicle travels in the first area at the first time in the future, and further predict, based on a current parameter of a wireless communication network of the first area, the network quality of the first area at the first time, to obtain the foregoing prediction information.

For example, the foregoing wireless communication network may include a wireless network such as a 4G/5G network, a next-generation wireless communication network, a GSM network, a WCDMA network, Bluetooth, Wi-Fi, or a call network, which is not limited.

For example, the traveling information of the vehicle may include a current location (for example, longitude, latitude, or altitude) of the vehicle, and a current traveling speed of the vehicle.

For example, the environment parameter of the vehicle may include traffic and road environment information around the vehicle, for example, a road condition (for example, a traffic volume, a vehicle speed, road pavement, or a road level) of the vehicle during traveling, obstacle information around the vehicle, traveling information of other traveling vehicle around the vehicle, and relevant information of pedestrians. In an actual application, the environment parameter may include a vehicle body size.

In some embodiments, the vehicle may use various installed sensors (for example, a millimeter-wave radar, a laser radar, and a camera) to sense a surrounding environment during traveling of the vehicle in real time, to collect the traveling information and the environment parameter of the vehicle. In some embodiments, the vehicle may also combine navigation map data to carry out systematic calculation and analysis on traveling data, to obtain the traveling information, for example, vehicle speed information of the vehicle. For example, the location of the vehicle may be obtained through GPS.

In some embodiments, the road side unit (RSU) may also transmit the collected traffic information (where the traveling information and the environment parameter may be included) to the core network device, which is not limited in this application.

Step 220: Determine, based on the prediction information, a control policy of the vehicle at a first time.

The control policy is used for controlling a traveling parameter of the remote driving vehicle. For example, the traveling parameter may be a parameter related to the wireless communication network of the vehicle.

In some embodiments, the traveling parameter of the vehicle may include a backhaul data parameter of the vehicle, where the backhaul data parameter may be used for controlling quality, data size, and a data format of backhaul data. The backhaul data refers to data uploaded by the vehicle to the remote driving server. For example, the backhaul data may include a backhaul video. The backhaul video may be a video of traffic and road environment information around the vehicle obtained in real time by a camera on the vehicle. In some embodiments, the backhaul data parameter may also be referred to as a parameter of a sensor, where the sensor is configured to obtain the backhaul data. For example, the sensor of the vehicle may include at least one of sensors configured to obtain the backhaul data such as a camera, a laser radar, and a millimeter-wave radar.

Since the backhaul data has a high requirement for network transmission delay, a control policy for the backhaul data parameter may be determined based on the predicted network quality in the future, to control the quality of the backhaul data, so that the quality of the backhaul data matches the network quality. For example, high-quality backhaul data may be returned when the network quality is good, while low-quality backhaul data may be returned when the network quality is poor.

In some embodiments, the traveling parameter of the vehicle may further include a vehicle status information parameter and an operation instruction parameter, which is not limited. The vehicle status information may include, for example, gear information of the vehicle, and vehicle speed information of the vehicle obtained in real time by a radar (for example, a laser radar or a millimeter-wave radar) on the vehicle, which is not limited. The operation instruction may include the operation instructions of the remote driver in the remote driving cabin, and the cloud platform may deliver the operation instruction to the vehicle. For example, the vehicle status information parameter may be used for controlling quality, a quantity, a size, and a data format of the vehicle status information, and the operation instruction parameter may be used for controlling quantity, a size, and an instruction format of the operation instructions for controlling the vehicle.

Step 230: Adjust, based on the control policy, a traveling parameter of the vehicle before the first time.

The traveling parameter is used for controlling the vehicle to travel in the first area at the first time.

In some embodiments, when the traveling parameter includes the backhaul data parameter, the adjusting, based on the control policy, a traveling parameter of the vehicle may be implemented as: when the network quality indicated by the prediction information is lower than the first threshold, adjusting, based on the control policy, the backhaul data parameter of the vehicle to a first backhaul data parameter, where the first backhaul data parameter is used for controlling data transmitted by the vehicle through the wireless communication network at the first time to be low-quality data; and when the network quality indicated by the prediction information is higher than the second threshold, adjusting, based on the control policy, the backhaul data parameter of the vehicle to a second backhaul data parameter, where the second backhaul data parameter is used for controlling the data transmitted by the vehicle through the wireless communication network at the first time to be high-quality data. A requirement for the network quality when the vehicle transmits the low-quality data is lower than a requirement for the network quality when the vehicle transmits the high-quality data. The first threshold and the second threshold may be preset.

When the data transmitted through the wireless communication network is uplink transmission data, for example, backhaul data (such as a backhaul video), the network quality may be indicated by at least one of the following parameters: transmission bandwidth, transmission delay, transmission reliability, and delay jitter of uplink transmission. When the data transmitted through the wireless communication network is downlink transmission data, for example, a control instruction for the vehicle, the network quality may be indicated by at least one of the following parameters: transmission bandwidth, transmission delay, transmission reliability, and delay jitter of downlink transmission.

An example in which the network quality is indicated by uplink transmission bandwidth and the data transmitted through the wireless communication network includes a backhaul video is used, when predicted uplink transmission bandwidth quality at the first time is lower than the set first threshold, quality of the backhaul video of the vehicle at the first time may be reduced to reduce a requirement for uplink network bandwidth. This ensures that the backhaul video collected by the remote driving vehicle can be successfully transmitted to the remote driving server under limited network conditions. When the predicted uplink transmission bandwidth quality at the first time is higher than the set second threshold, the quality of the backhaul video of the vehicle at the first time may be improved, to transmit a high-quality remote driving video to the remote driving server.

In a possible implementation, the backhaul data parameter of the vehicle may be adjusted by adjusting a sensor parameter of the vehicle. For example, when the backhaul data includes a backhaul video, the backhaul data parameter include at least one of a resolution or a frame rate of the backhaul video. An example in which the backhaul data parameter includes at least one of a resolution or a frame rate is used, when the backhaul video of the vehicle is controlled, based on the control policy, to be a low-quality video, at least one of a resolution or a frame rate of a camera may be reduced to obtain a low-quality backhaul video, thereby reducing a requirement for uplink network bandwidth. This ensures that the backhaul video collected by the remote driving vehicle can be successfully transmitted to the remote driving server under limited network conditions. When the backhaul video of the vehicle is controlled, based on the control policy, to be a high-quality video, at least one of the resolution or the frame rate of the camera may be increased to obtain a high-quality backhaul video, thereby transmitting a high-quality remote driving video to the remote driving server.

In some embodiments, the second threshold is greater than the first threshold. In this way, a buffer threshold interval may be formed between the first threshold and the second threshold. When the network quality indicated by the prediction information is within the buffer threshold interval, the control policy may be skipping adjusting the traveling parameter (for example, the backhaul data parameter) of the vehicle. To be specific, the traveling parameter of the vehicle at the first time may remain unchanged when compared with that at the current time. This helps avoid frequent adjustment on the traveling parameter, thereby helping improve the system stability.

Following the foregoing example, a current backhaul video of the vehicle is a low-quality video, and when it is predicted that at a time #1, the uplink transmission bandwidth quality is higher than the first threshold but still lower than the second threshold, it may be determined to skip adjusting quality of the backhaul video. That is, the backhaul video is still kept as a low-quality video. When it is predicted that at a time #2, the uplink transmission bandwidth quality is higher than the second threshold, the quality of the backhaul video at the time #2 in the future may be adjusted to obtain a high-quality video. In addition, when it is predicted that at a time #3, the uplink transmission bandwidth quality is lower than the second threshold but still higher than the first threshold, it may be determined to skip adjusting the quality of the backhaul video. That is, the backhaul video is still kept as a high-quality video. When it is predicted that at a time #4, the uplink transmission bandwidth quality is lower than the first threshold, the quality of the backhaul video at the time #4 in the future may be adjusted to obtain a low-quality video. The time #1, time #2, time #3, and time #4 may be different times in sequence. Therefore, by setting the second threshold to be greater than the first threshold, frequent switching of the traveling parameter can be avoided.

In other embodiments, the first threshold is equal to the second threshold. This is not limited in this application.

It is to be understood that in step 230, after the network quality change at the first time in the future is obtained and before the first time, by adjusting the traveling parameter of the vehicle based on the control policy, the traveling parameter of the vehicle can be adjusted before the network quality actually changes. This helps reduce or avoid a problem of network lags in the vehicle caused by sudden change of a network, thereby helping improve the safety of vehicle traveling.

Therefore, this embodiment of this application can predict a network quality change at a future time, so that the remote driving system can adjust, based on the predicted network quality, the traveling parameter of the vehicle before the network quality actually changes. This helps reduce or avoid a problem of backhaul data lags in the vehicle caused by a sudden change of a network, thereby helping improve the safety of vehicle traveling.

In some embodiments, in the method 200, the vehicle may further send a notification message to a server, where the notification message is used for notifying the vehicle that the parameter of the sensor has been adjusted based on the control policy. The server may be the remote driving server. In this way, the server may determine, based on the notification message, the control policy of the vehicle, for example, determining the quality of the backhaul data, to make a timely response based on the control policy, thereby helping improve the overall reliability of the system.

FIG. 3 is a schematic flowchart of another remote driving control method 300 according to an embodiment of this application. As shown in FIG. 3, the method 300 may include step 301 to step 308.

Step 301: A vehicle operates normally.

The vehicle is a remote driving vehicle.

Step 302: The vehicle receives and parses prediction information used for indicating network quality.

For example, the vehicle may receive prediction information used for indicating network quality from a core network device. The prediction information is predicted by the core network device, and is used for indicating network quality of a first area at a first time. For details, reference may be made to step 210 in FIG. 2, which are not described herein again.

Step 303: Determine, based on the prediction information, whether uplink (UL) transmission bandwidth is lower than a threshold 1, and when the uplink transmission bandwidth is lower than the threshold 1, step 304 is performed.

The uplink transmission bandwidth may be an example of the network quality, and the threshold 1 is an example of the first threshold.

For example, when the UL transmission bandwidth is lower than the threshold 1, a control policy is used for controlling backhaul data to be low-quality data, and step 304 may be performed next.

Step 304: The vehicle adjusts a traveling parameter (for example, a backhaul data parameter) to generate low-quality backhaul data.

Step 305: Determine, based on the prediction information, whether UL transmission bandwidth is higher than a threshold 2, and when the uplink transmission bandwidth is higher than the threshold 2, step 306 is performed.

For example, the threshold 2 is an example of the second threshold.

For example, when the UL transmission bandwidth is higher than the threshold 2, a control policy is used for controlling backhaul data to be high-quality data, and step 306 may be performed next.

Step 306: The vehicle adjusts a traveling parameter (for example, a backhaul data) to generate high-quality backhaul data.

When the UL transmission bandwidth is higher than or equal to the threshold 1, and lower than or equal to the threshold 2, no operation may be performed. In other words, the original control policy remains unchanged, and the traveling parameter of the vehicle is not adjusted.

For example, the traveling parameter may be adjusted based on the control policy before the first time, to adjust the traveling parameter of the vehicle before the network quality actually changes, so that the quality of the backhaul data matches the network quality. For example, the traveling parameter is adjusted based on the control policy. For details, reference may be made to related descriptions in FIG. 2, which are not described herein again.

Step 307: The vehicle transmits a notification message to a remote driving server.

Step 308: The vehicle operates normally.

The notification message is used for notifying the vehicle that the traveling parameter has been adjusted based on the control policy.

Therefore, this embodiment of this application can predict a network quality change at a future time, so that the remote driving system can adjust, based on the predicted network quality, the traveling parameter of the vehicle before the network quality actually changes. This helps reduce or avoid a problem of backhaul data lags in the vehicle caused by a sudden change of a network, thereby helping improve the safety of vehicle traveling.

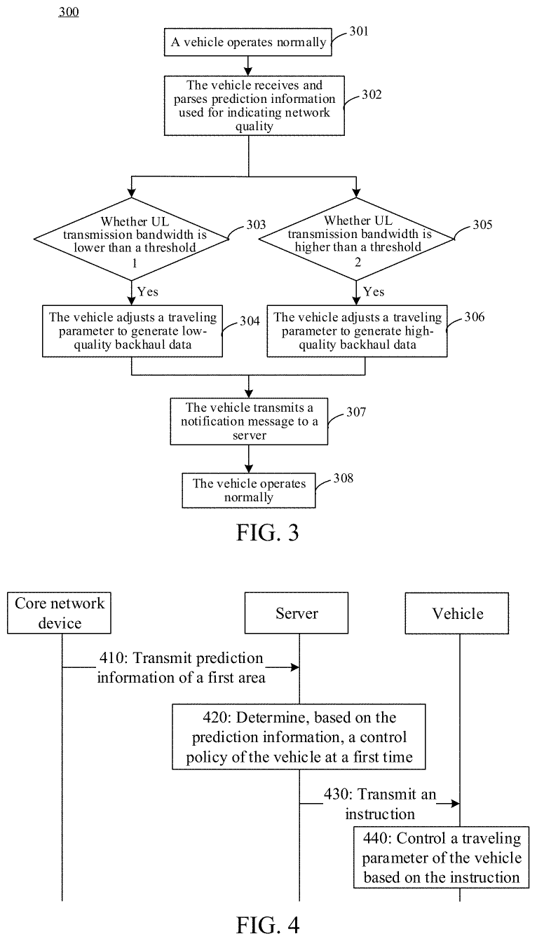

FIG. 4 is a schematic flowchart of another remote driving control method 400 according to an embodiment of this application. The method 400 is applicable to a remote driving system, and the remote driving system includes a core network device, a server, and a terminal device. The core network device, the server, or the terminal device may be, for example, the corresponding devices in FIG. 1. For ease of description, the following embodiments are described by using an example in which the terminal device is a remote driving vehicle. However, the embodiments of this application are not limited thereto.

In the method 400, the server obtains prediction information used for indicating network quality, and determines a control policy of the vehicle at a first time based on the prediction information.

In other words, in the method 400, after the remote driving server receives the prediction information used for indicating the network quality, the control policy of the vehicle is adjusted.

As shown in FIG. 4, the method 400 may include step 410 to step 440.

Step 410: The core network device transmits prediction information of a first area to the server.

The prediction information is used for indicating network quality of the first area at the first time. The vehicle travels in the first area at the first time through remote driving.

Step 420: The server determines, based on the prediction information, a control policy of the vehicle at a first time.

For example, for the prediction information and the control policy, reference may be made to related descriptions in FIG. 2. Details are not described herein again.

Step 430: The server transmits an instruction to the vehicle, where the instruction is used for instructing the vehicle to adjust, based on the control policy, a traveling parameter of the vehicle before the first time, and the traveling parameter is used for controlling the vehicle to travel in the first area at the first time through remote driving.

Step 440: The vehicle controls the traveling parameter of the vehicle based on the instruction.

For example, for a process of adjusting the traveling parameter of the vehicle based on the control policy, reference may be made to related descriptions in FIG. 2. Details are not described herein again.

Therefore, this embodiment of this application can predict a network quality change at a future time, so that the remote driving system can adjust, based on the predicted network quality, the traveling parameter of the vehicle before the network quality actually changes. This helps reduce or avoid a problem of backhaul data lags in the vehicle caused by a sudden change of a network, thereby helping improve the safety of vehicle traveling.

In addition, in the embodiments of this application, each of the remote driving vehicle and the remote driving server may receive the prediction information of the network quality predicted by a network, and each may initiate adjustment of the control policy, forming mutual backup and mutual confirmation between the vehicle and the server. This is helpful when one of the vehicle or the server cannot receive a network quality prediction signal in time, the other one can still adjust the traveling parameter in time based on the network quality, thereby improving the overall reliability of the system.

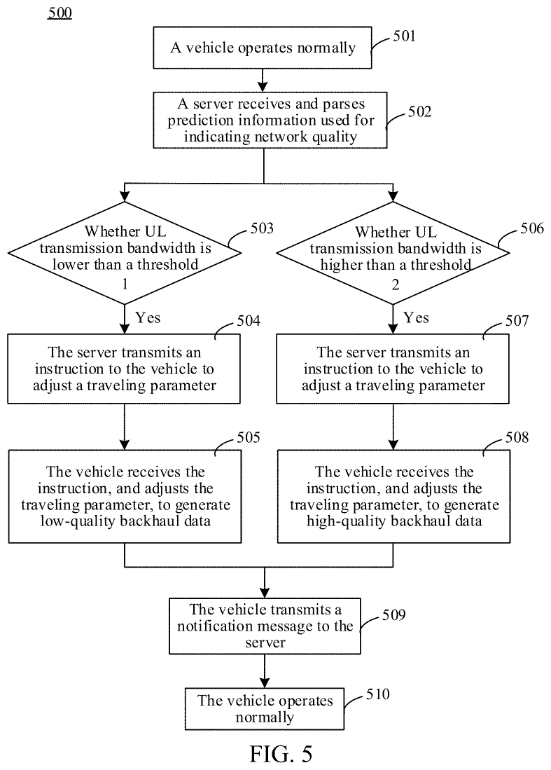

FIG. 5 is a schematic flowchart of another remote driving control method 500 according to an embodiment of this application. As shown in FIG. 5, the method 500 may include step 501 to step 510.

Step 501: A vehicle operates normally.

The vehicle is a remote driving vehicle.

Step 502: A server receives and parses prediction information used for indicating network quality.

For example, the server may receive the prediction information used for indicating network quality from a core network device. The prediction information is predicted by the core network device, and is used for indicating network quality of a first area at a first time. For details, reference may be made to step 210 in FIG. 2, which are not described herein again.

Step 503: Determine, based on the prediction information, whether uplink (UL) transmission bandwidth is lower than a threshold 1, and when the uplink transmission bandwidth is lower than the threshold 1, step 504 is performed.

The uplink transmission bandwidth may be an example for indicating the network quality, and the threshold 1 is an example of the first threshold.

For example, when the UL transmission bandwidth is lower than the threshold 1, a control policy is used for controlling backhaul data to be low-quality data, and step 504 may be performed next.

Step 504: The server transmits an instruction to the vehicle, where the instruction is used for adjusting a traveling parameter (for example, a backhaul data parameter) to generate low-quality backhaul data.

Step 505: The vehicle receives the instruction and adjusts the traveling parameter (for example, the backhaul data parameter) to generate low-quality backhaul data.

Step 506: Determine, based on the prediction information, whether UL transmission bandwidth is higher than a threshold 2, and when the uplink transmission bandwidth is higher than the threshold 2, step 507 is performed.

For example, the threshold 2 is an example of the second threshold.

For example, when the UL transmission bandwidth is greater than the threshold 2, a control policy is used for controlling backhaul data to be high-quality data, and step 507 may be performed next.

Step 507: The server transmits an instruction to the vehicle, where the instruction is used for adjusting a traveling parameter (for example, a backhaul data parameter) to generate high-quality backhaul data.

Step 505: The vehicle receives the instruction and adjusts the traveling parameter (for example, the backhaul data parameter) to generate high-quality backhaul data.

When the UL transmission bandwidth is higher than or equal to the threshold 1, and lower than or equal to the threshold 2, the server may not perform an operation. In other words, the original control policy remains unchanged, and the traveling parameter of the vehicle is not adjusted.

For example, the traveling parameter may be adjusted based on the control policy before the first time, to adjust the traveling parameter of the vehicle before the network quality actually changes, so that the quality of the backhaul data matches the network quality. For example, the traveling parameter is adjusted based on the control policy. For details, reference may be made to related descriptions in FIG. 2, which are not described herein again.

Step 509: The vehicle transmits a notification message to a remote driving server.

The notification message is used for notifying the vehicle that the traveling parameter has been adjusted based on the control policy.

Therefore, this embodiment of this application can predict a network quality change at a future time, so that the remote driving system can adjust, based on the predicted network quality, the traveling parameter of the vehicle before the network quality actually changes. This helps reduce or avoid a problem of backhaul data lags in the vehicle caused by a sudden change of a network, thereby helping improve the safety of vehicle traveling.

The implementations of this application are described in detail above with reference to the accompanying drawings. However, this application is not limited to the details in the foregoing implementations, a plurality of simple deformations may be made to the technical solutions of this application within a range of the technical concept of this application, and these simple deformations all fall within the protection scope of this application. For example, the technical features described in the foregoing implementations may be combined in any suitable manner without contradiction. To avoid unnecessary repetition, various possible combinations are not further described in this application. In another example, different implementations of this application may also be arbitrarily combined without departing from the idea of this application, and these combinations shall also be regarded as content disclosed in this application.

It is to be further understood that, in the method embodiments of this application, the sequence numbers of the foregoing processes do not mean an execution sequence, and the execution sequence of each process is to be determined by its function and inherent logic, and is not to constitute any limitation to the implementation process of the embodiments of this application. It is to be understood that the sequence numbers are interchangeable in proper circumstances, so that the embodiments of this application described herein can be implemented in other sequences than the sequence illustrated or described herein.

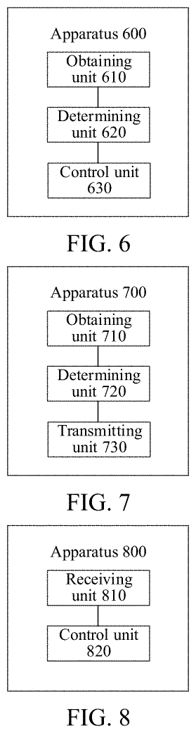

The method embodiments of this application are described in detail above, and apparatus embodiments of this application are described in detail in the following with reference to FIG. 6 to FIG. 9.

FIG. 6 is a schematic block diagram of a remote driving control apparatus 600 according to an embodiment of this application. For example, the apparatus 600 may be a terminal device, and may be implemented as a remote driving vehicle. As shown in FIG. 6, the apparatus 600 may include an obtaining unit 610, a determining unit 620, and a control unit 630.

The obtaining unit 610 is configured to obtain prediction information of a first area, where the prediction information is used for indicating network quality of the first area at a first time.

The determining unit 620 is configured to determine, based on the prediction information, a control policy of the remote driving at the first time.

The control unit 630 is configured to adjust, based on the control policy, a traveling parameter of the vehicle before the first time, where the traveling parameter is used for controlling the vehicle to travel in the first area at the first time through remote driving.

In some embodiments, the traveling parameter include a backhaul data parameter, and the backhaul data parameter is used for controlling quality of backhaul data of the vehicle.

The control unit 630 is further configured to: when the prediction information indicates that the network quality is lower than a first threshold, adjust, based on the control policy, the backhaul data parameter of the vehicle to a first backhaul data parameter, where the first backhaul data parameter is used for controlling the vehicle to transmit low-quality data through a wireless communication network at the first time; and

when the prediction information indicates that the network quality is higher than a second threshold, adjust, based on the control policy, the backhaul data parameter of the vehicle to a second backhaul data parameter, where the second backhaul data parameter is used for controlling the vehicle to transmit high-quality data through the wireless communication network at the first time.

A requirement for the network quality when the vehicle transmits the low-quality data is lower than a requirement for the network quality when the vehicle transmits the high-quality data.

In some embodiments, the second threshold is greater than the first threshold; and when the prediction information indicates that the network quality is between the first threshold and the second threshold, the control unit 630 is further configured to keep, based on the control policy, the backhaul data parameter of the vehicle unchanged.

In some embodiments, the data transmitted through a wireless communication network includes the backhaul data of the vehicle, and the traveling parameter includes the backhaul data parameter of the vehicle.

In some embodiments, the network quality is indicated by at least one of the following parameters: transmission bandwidth, transmission delay, transmission reliability, and delay jitter of uplink transmission.

In some embodiments, the apparatus 600 further includes a transmitting unit, and the transmitting unit is configured to transmit a notification message to a server, where the notification message is used for notifying the server that the traveling parameter of the vehicle has been adjusted based on the control policy.

In some embodiments, the prediction information is determined by a core network device based on a parameter of the wireless communication network and traveling information of the vehicle.

It is to be understood that the apparatus embodiments may correspond to the method embodiments. For similar descriptions, reference may be made to the method embodiments. To avoid repetition, details are not described herein again. The apparatus 600 shown in FIG. 6 may correspond to the vehicle in the method 200 or the method 300 in the embodiments of this application. The foregoing and other operations and/or functions of the modules in the apparatus 600 are respectively for implementing corresponding procedures of the vehicle in the method 200 or the method 300. For brevity, details are not described herein again.

FIG. 7 is a schematic block diagram of a remote driving control apparatus 700 according to an embodiment of this application. For example, the apparatus 700 may be a server and may be implemented as a remote driving server. As shown in FIG. 7, the apparatus 700 may include an obtaining unit 710, a determining unit 720, and a transmitting unit 730.

The obtaining unit 710 is configured to obtain prediction information of a first area, where the prediction information is used for indicating network quality of the first area at a first time.

The determining unit 720 is configured to determine, based on the prediction information, a control policy of a remote driving vehicle at the first time.

The transmitting unit 730 is configured to transmit an instruction to the vehicle, where the instruction is used for instructing the vehicle to adjust, based on the control policy, a traveling parameter of the vehicle before the first time, and the traveling parameter is used for controlling the vehicle to travel in the first area at the first time through remote driving.

In some embodiments, the apparatus further includes a receiving unit, and the receiving unit is configured to receive a notification message from the vehicle, where the notification message is used for notifying that the vehicle has adjusted the traveling parameter based on the control policy.

In some embodiments, the traveling parameter includes a backhaul data parameter, and the backhaul data parameter is used for controlling quality of backhaul data of the vehicle. When the prediction information indicates that the network quality is lower than a first threshold, the control policy is used for adjusting the backhaul data parameter of the vehicle to a first backhaul data parameter, where the first backhaul data parameter is used for controlling the vehicle to transmit low-quality data through a wireless communication network at the first time.

When the prediction information indicates that the network quality is higher than a second threshold, the control policy is used for adjusting the backhaul data parameter of the vehicle to a second backhaul data parameter, where the second backhaul data parameter is used for controlling the vehicle to transmit high-quality data through the wireless communication network at the first time.

A requirement for the network quality when the vehicle transmits the low-quality data is lower than a requirement for the network quality when the vehicle transmits the high-quality data.

In some embodiments, the second threshold is greater than the first threshold.

In some embodiments, the data transmitted through a wireless communication network includes the backhaul data of the vehicle, and the traveling parameter includes the backhaul data parameter of the vehicle.

In some embodiments, the network quality is indicated by at least one of the following parameters:

transmission bandwidth, transmission delay, transmission reliability, and delay jitter of uplink transmission.

In some embodiments, the prediction information is determined by a core network device based on a parameter of the wireless communication network and traveling information of the vehicle.

It is to be understood that the apparatus embodiments may correspond to the method embodiments. For similar descriptions, reference may be made to the method embodiments. To avoid repetition, details are not described herein again. For example, the apparatus 700 shown in FIG. 7 may correspond to the server (the remote driving server) in the method 400 or the method 500 in the embodiments of this application. The foregoing and other operations and/or functions of the modules in the apparatus 700 are respectively for implementing corresponding procedures of the server in the method 400 or the method 500. For brevity, details are not described herein again.

FIG. 8 is a schematic block diagram of a remote driving control apparatus 800 according to an embodiment of this application. For example, the apparatus 800 may be a terminal device and may be implemented as a remote driving vehicle. As shown in FIG. 8, the apparatus 800 may include a receiving unit 810 and a control unit 820.

The receiving unit 810 is configured to receive an instruction from a server, where the instruction is used for instructing the vehicle to adjust, based on a control policy, a traveling parameter of the vehicle before a first time, the control policy is determined based on prediction information of a first area, the prediction information is used for indicating network quality of the first area at the first time, and the traveling parameter is used for controlling the vehicle to travel in the first area at the first time.

The control unit 820 is configured to adjust the traveling parameter based on the instruction.

In some embodiments, the apparatus 800 further includes a transmitting unit, and the transmitting unit is configured to transmit a notification message to the server, where the notification message is used for notifying that the vehicle has adjusted the traveling parameter based on the control policy.

In some embodiments, the traveling parameter includes a backhaul data parameter, and the backhaul data parameter is used for controlling quality of backhaul data of the vehicle. The control unit 820 is further configured to: when the prediction information indicates that the network quality is lower than a first threshold, adjust, based on the control policy, the backhaul data parameter of the vehicle to a first backhaul data parameter, where the first backhaul data parameter is used for controlling the vehicle to transmit low-quality data through a wireless communication network at the first time; and

when the prediction information indicates that the network quality is higher than a second threshold, adjust, based on the control policy, the backhaul data parameter of the vehicle to a second backhaul data parameter, where the second backhaul data parameter is used for controlling the vehicle to transmit high-quality data through the wireless communication network at the first time.

A requirement for the network quality when the vehicle transmits the low-quality data is lower than a requirement for the network quality when the vehicle transmits the high-quality data.

In some embodiments, the second threshold is greater than the first threshold.

In some embodiments, the data transmitted through a wireless communication network includes the backhaul data of the vehicle, and the traveling parameter includes the backhaul data parameter of the vehicle.

In some embodiments, the network quality is indicated by at least one of the following parameters:

transmission bandwidth, transmission delay, transmission reliability, and delay jitter of uplink transmission.

In some embodiments, the prediction information is determined by a core network device based on a parameter of the wireless communication network and traveling information of the vehicle.

It is to be understood that the apparatus embodiments may correspond to the method embodiments. For similar descriptions, reference may be made to the method embodiments. To avoid repetition, details are not described herein again. For example, the apparatus 800 shown in FIG. 8 may correspond to the vehicle in the method 400 or the method 500 in the embodiments of this application. The foregoing and other operations and/or functions of the modules in the apparatus 800 are respectively for implementing corresponding procedures of the vehicle in the method 400 or the method 500. For brevity, details are not described herein again.

The foregoing describes the remote driving control apparatus in the embodiments of this application with reference to the accompanying drawings from a perspective of functional modules. It is to be understood that the functional module may be implemented in a form of hardware, implemented by instructions in a form of software, or implemented by a combination of hardware and software modules. Each step of the method embodiments in the embodiments of this application may be completed by an integrated logic circuit of hardware in a processor and/or instructions in a form of software. The steps of the method disclosed with reference to the embodiments of this application may be directly performed and completed by using a hardware decoding processor, or may be performed and completed by using a combination of hardware and software modules in a decoding processor. In some embodiments, the software module may be located in a mature storage medium in the field, such as a random access memory, a flash memory, a read-only memory, a programmable read-only memory, an electrically erasable programmable memory, or a register. The storage medium is located in a memory. A processor reads information in the memory and completes the steps in the method embodiments in combination with hardware thereof.

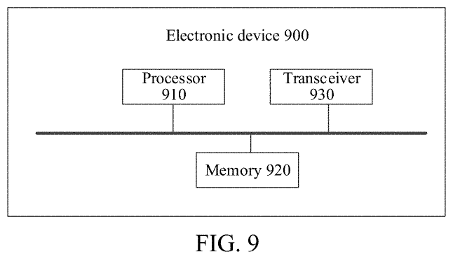

FIG. 9 is a schematic block diagram of an electronic device 900 according to an embodiment of this application.

As shown in FIG. 9, the electronic device 900 may include:

a processor 910 and a memory 920, where the memory 920 is configured to store a computer program, and transmit the computer program to the processor 910. In other words, the processor 910 may invoke the computer program from the memory 920 and run the computer program, to implement the remote driving control method provided in the embodiments of this application.

For example, the processor 910 may be configured to perform the foregoing method embodiments based on instructions in the computer program.

In some embodiments of this application, the processor 910 may include but is not limited to:

a general-purpose processor, a digital signal processor (DSP), an application-specific integrated circuit (ASIC), a field programmable gate array (FPGA) or another programmable logical device, a discrete gate or a transistor logical device, or a discrete hardware component.

In some embodiments of this application, the memory 920 includes but is not limited to:

a volatile memory and/or a non-volatile memory. The non-volatile memory may be a read-only memory (ROM), a programmable ROM (PROM), an erasable programmable read-only memory (EPROM), an electrically erasable programmable read-only memory (EEPROM), or a flash memory. The volatile memory may be a random access memory (RAM), and is used as an external cache. Through exemplary but not limitative description, many forms of RAMs are available, for example, a static random access memory (SRAM), a dynamic random access memory (DRAM), a synchronous dynamic random access memory (SDRAM), a double data rate synchronous dynamic random access memory (DDR SDRAM), an enhanced synchronous dynamic random access memory (ESDRAM), a synchlink dynamic random access memory (SLDRAM), and a direct Rambus random access memory (DR RAM).

In some embodiments of this application, the computer program may be divided into one or more modules, and the one or more modules are stored in the memory 920 and executed by the processor 910 to complete the method provided in this application. The one or more modules may be a series of computer program instruction segments that can accomplish specific functions, and the instruction segments are used for describing an execution process of the computer program in the electronic device.

As shown in FIG. 9, the electronic device 900 may further include:

a transceiver 930, where the transceiver 930 may be connected to the processor 910 or the memory 920.

The processor 910 may control the transceiver 930 to communicate with another device, for example, transmit information or data to another device, or receive information or data transmitted by another device. The transceiver 930 may include a transmitter and a receiver. The transceiver 930 may further include an antenna, and there may be one or more antennas.

It is to be understood that, the components in the electronic device are connected by using a bus system, and in addition to a data bus, the bus system further includes a power bus, a control bus, and a status signal bus.

This application further provides a computer storage medium, storing a computer program, where when the computer program is executed by a computer, the computer is caused to perform the method in the foregoing method embodiments. In other words, an embodiment of this application further provides a computer program product including instructions, where when the instructions are executed by a computer, the computer is caused to perform the method in the foregoing method embodiments.

When the embodiments are implemented through software, all or some of the embodiments may be implemented in a form of a computer program product. The computer program product includes one or more computer instructions. When the computer instructions are loaded and executed on a computer, all or some of the procedures or functions according to the embodiments of this application are generated. The computer may be a general-purpose computer, a dedicated computer, a computer network, or another programmable apparatus. The computer instructions may be stored in a non-transitory computer-readable storage medium, or may be transmitted from one computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by a computer, or a data storage device, such as a server or a data center, integrating one or more usable media. The usable medium may be a magnetic medium (for example, a soft disk, a hard disk, or a magnetic tape), an optical medium (for example, a digital video disc (DVD)), or a semiconductor medium (for example, a solid state disk (SSD)).

A person of ordinary skill in the art may be aware that the modules and algorithm steps described with reference to the examples described in the embodiments disclosed in this specification can be implemented in electronic hardware, or a combination of computer software and electronic hardware. Whether the functions are executed in a form of hardware or software depends on particular applications and design constraint conditions of the technical solutions. A person skilled in the art may use different methods to implement the described functions for each particular application, but it is not to be considered that the implementation goes beyond the scope of the present application.

In the several embodiments provided in this application, it is to be understood that the disclosed system, apparatus, and method may be implemented in other manners. For example, the described apparatus embodiments are merely exemplary. For example, the module division is merely logical function division and there may be other division manners during actual implementation. For example, a plurality of modules or components may be combined or integrated into another system, or some features may be ignored or not performed. In addition, the displayed or discussed mutual couplings or direct couplings or communication connections may be implemented by using some interfaces. The indirect couplings or communication connections between the apparatuses or modules may be implemented in electronic, mechanical, or other forms.

In this application, the term “module” or “unit” in this application refers to a computer program or part of the computer program that has a predefined function and works together with other related parts to achieve a predefined goal and may be all or partially implemented by using software, hardware (e.g., processing circuitry and/or memory configured to perform the predefined functions), or a combination thereof. Each module or unit can be implemented using one or more processors (or processors and memory). Likewise, a processor (or processors and memory) can be used to implement one or more modules or units. Moreover, each module or unit can be part of an overall module or unit that includes the functionalities of the module or unit. The modules described as separate components may or may not be physically separate, and the components displayed as modules may or may not be physical modules, that is, may be located in one position, or may be distributed on a plurality of network units. Some or all of the modules may be selected based on an actual requirement to achieve the objectives of the solutions of the embodiments. For example, the functional modules in the embodiments of this application may be integrated into one processing module, or each of the modules may exist alone physically, or two or more modules may be integrated into one module.

What is claimed is:

1. A remote driving control method performed by an electronic device mounted on a vehicle, the method comprising:
obtaining prediction information of a first area, the prediction information indicating network quality of the first area at a first time when the vehicle is scheduled to travel in the first area at the first time;
determining, based on the predicted information, a control policy of the vehicle at the first time;
adjusting a traveling parameter of the vehicle based on the control policy before the first time; and
controlling the vehicle to travel in the first area at the first time through remote driving in accordance with the adjusted traveling parameter.

2. The method according to claim 1, wherein the traveling parameter comprises a backhaul data parameter for controlling quality of backhaul data of the vehicle; and the adjusting a traveling parameter of the vehicle based on the control policy before the first time comprising:
when the prediction information indicates that the network quality is lower than a first threshold, adjusting, based on the control policy, the backhaul data parameter of the vehicle to a first backhaul data parameter, wherein the first backhaul data parameter is used for controlling the vehicle to transmit low-quality data through a wireless communication network at the first time; and
when the prediction information indicates that the network quality is higher than a second threshold, adjusting, based on the control policy, the backhaul data parameter of the vehicle to a second backhaul data parameter, wherein the second backhaul data parameter is used for controlling the vehicle to transmit high-quality data through the wireless communication network at the first time.

3. The method according to claim 2, wherein a requirement for the network quality when the vehicle transmits the low-quality data is lower than a requirement for the network quality when the vehicle transmits the high-quality data.

4. The method according to claim 2, wherein the second threshold is greater than the first threshold; and
when the prediction information indicates that the network quality is between the first threshold and the second threshold, the adjusting a traveling parameter of the vehicle based on the control policy before the first time comprising:
keeping, based on the control policy, the backhaul data parameter of the vehicle unchanged.

5. The method according to claim 1, wherein the network quality is indicated by at least one of the following parameters:
transmission bandwidth, transmission delay, transmission reliability, and delay jitter of uplink transmission.

6. The method according to claim 1, wherein the method further comprises:
after adjusting the traveling parameter of the vehicle based on the control policy before the first time, transmitting a notification message to a server, wherein the notification message is used for notifying the server that the traveling parameter of the vehicle has been adjusted based on the control policy.

7. The method according to claim 1, wherein the obtaining prediction information of a first area comprises:
obtaining the prediction information of the first area from a core network device, wherein the prediction information is determined by the core network device based on a parameter of the wireless communication network and traveling information of the vehicle.

8. An electronic device mounted on a vehicle, comprising:
a processor and a memory, wherein the memory stores computer-executable instructions that, when executed by the processor, cause the electronic device to perform a remote driving control method including:
obtaining prediction information of a first area, the prediction information indicating network quality of the first area at a first time when the vehicle is scheduled to travel in the first area at the first time;
obtaining, based on the predicted information, a control policy of the vehicle at the first time;
adjusting a traveling parameter of the vehicle based on the control policy before the first time; and
controlling the vehicle to travel in the first area at the first time through remote driving in accordance with the adjusted traveling parameter.

9. The electronic device according to claim 8, wherein the traveling parameter comprises a backhaul data parameter for controlling quality of backhaul data of the vehicle; and the adjusting a traveling parameter of the vehicle based on the control policy before the first time comprising:
when the prediction information indicates that the network quality is lower than a first threshold, adjusting, based on the control policy, the backhaul data parameter of the vehicle to a first backhaul data parameter, wherein the first backhaul data parameter is used for controlling the vehicle to transmit low-quality data through a wireless communication network at the first time; and
when the prediction information indicates that the network quality is higher than a second threshold, adjusting, based on the control policy, the backhaul data parameter of the vehicle to a second backhaul data parameter, wherein the second backhaul data parameter is used for controlling the vehicle to transmit high-quality data through the wireless communication network at the first time.

10. The electronic device according to claim 9, wherein a requirement for the network quality when the vehicle transmits the low-quality data is lower than a requirement for the network quality when the vehicle transmits the high-quality data.

11. The electronic device according to claim 9, wherein the second threshold is greater than the first threshold; and
when the prediction information indicates that the network quality is between the first threshold and the second threshold, the adjusting a traveling parameter of the vehicle based on the control policy before the first time comprising:
keeping, based on the control policy, the backhaul data parameter of the vehicle unchanged.

12. The electronic device according to claim 8, wherein the network quality is indicated by at least one of the following parameters:
transmission bandwidth, transmission delay, transmission reliability, and delay jitter of uplink transmission.

13. The electronic device according to claim 8, wherein the method further comprises:
after adjusting the traveling parameter of the vehicle based on the control policy before the first time, transmitting a notification message to a server, wherein the notification message is used for notifying the server that the traveling parameter of the vehicle has been adjusted based on the control policy.

14. The electronic device according to claim 8, wherein the obtaining prediction information of a first area comprises:
obtaining the prediction information of the first area from a core network device, wherein the prediction information is determined by the core network device based on a parameter of the wireless communication network and traveling information of the vehicle.

15. A non-transitory computer-readable storage medium, comprising computer-executable instructions, wherein the computer-executable instructions, when executed by a processor of an electronic device mounted on a vehicle, cause the electronic device to perform a remote driving control method including:
obtaining prediction information of a first area, the prediction information indicating network quality of the first area at a first time when the vehicle is scheduled to travel in the first area at the first time;
obtaining, based on the predicted information, a control policy of the vehicle at the first time;
adjusting a traveling parameter of the vehicle based on the control policy before the first time; and
controlling the vehicle to travel in the first area at the first time through remote driving in accordance with the adjusted traveling parameter.

16. The non-transitory computer-readable storage medium according to claim 15, wherein the traveling parameter comprises a backhaul data parameter for controlling quality of backhaul data of the vehicle; and the adjusting a traveling parameter of the vehicle based on the control policy before the first time comprising:
when the prediction information indicates that the network quality is lower than a first threshold, adjusting, based on the control policy, the backhaul data parameter of the vehicle to a first backhaul data parameter, wherein the first backhaul data parameter is used for controlling the vehicle to transmit low-quality data through a wireless communication network at the first time; and
when the prediction information indicates that the network quality is higher than a second threshold, adjusting, based on the control policy, the backhaul data parameter of the vehicle to a second backhaul data parameter, wherein the second backhaul data parameter is used for controlling the vehicle to transmit high-quality data through the wireless communication network at the first time.

17. The non-transitory computer-readable storage medium according to claim 16, wherein a requirement for the network quality when the vehicle transmits the low-quality data is lower than a requirement for the network quality when the vehicle transmits the high-quality data.

18. The non-transitory computer-readable storage medium according to claim 16, wherein the second threshold is greater than the first threshold; and
when the prediction information indicates that the network quality is between the first threshold and the second threshold, the adjusting a traveling parameter of the vehicle based on the control policy before the first time comprising:
keeping, based on the control policy, the backhaul data parameter of the vehicle unchanged.

19. The non-transitory computer-readable storage medium according to claim 15, wherein the network quality is indicated by at least one of the following parameters:
transmission bandwidth, transmission delay, transmission reliability, and delay jitter of uplink transmission.

20. The non-transitory computer-readable storage medium according to claim 15, wherein the method further comprises:
after adjusting the traveling parameter of the vehicle based on the control policy before the first time, transmitting a notification message to a server, wherein the notification message is used for notifying the server that the traveling parameter of the vehicle has been adjusted based on the control policy.
